(19) United States
(12) Patent Application Publication
(10) Pub. No.: US 2018/0333645 A1
(43) Pub. Date: Nov. 22, 2018

(54) FILE STORAGE USING A VIDEO PORT

(71) Applicant: Microsoft Technology Licensing, LLC, Redmond, WA (US)

(72) Inventors: John Joseph DALY, JR., Carnation, WA (US); Glen Theodore KIRK, Carnation, WA (US)

(21) Appl. No.: 15/601,530

(22) Filed: May 22, 2017

(51) Int. Cl. A63F 13/95

(52) U.S. Cl. CPC A63F 13/95; A63F 2300/206

(57) ABSTRACT

Examples described herein generally relate to a storage device for transferring a file. The storage device may include a data store storing a plurality of bitmap images representing portions of a data file. Each bitmap image may include at least a portion of the data file and header information for the portion of the data file. The storage device may also include a video-out port and a processor configured to scan the bitmap images as frames to the video-out port. A computer device for accessing a file from the storage device may receive, via a video-in port, the plurality of video frames and reconstruct the requested at least a portion of the file based on the data portion of each bitmap image according to the header portions.

### CROSS-REFERENCE TO RELATED APPLICATIONS

This application is related co-pending U.S. Patent application entitled “FILE TRANSFER VIA A VIDEO PORT” by John Joseph Daly, et al., having Attorney Docket No. 402076-US-NP (037834-00085), which is filed concurrently herewith, assigned to the assignee hereof, and expressly incorporated by reference herein.

### BACKGROUND

Computer users may desire to transfer large computer files. For example, large computer files such as video games, high quality video, or research data sets may be on the order of tens or hundreds of gigabytes (GB). In one example use case, a video game developer may generate large game resource files using a personal computer (PC). To test the video game on a game console, the video game developer may transfer the large game resource files to the game console.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

The disclosure provides a storage device for transferring a file. The storage device may include a data store storing a plurality of bitmap images representing portions of a data file. Each bitmap image may include at least a portion of the data file and header information for the portion of the data file. The storage device may also include a video-out port and a processor configured to scan the bitmap images as frames to the video-out port.

The disclosure provides a method of transferring a file. The method may include storing a plurality of bitmap images representing portions of a data file in a data store. Each bitmap image may include at least a portion of the data file and header information for the portion of the data file. The method may include scanning, from the data store, one or more of the plurality of bitmap images as frames to a video-out port.

The disclosure provides a computer device for accessing a file from a storage device. The computer device may include a memory storing one or more parameters or instructions for executing an operating system. The computer device may include a video-in port configured to receive a plurality of frames. The video-in port may be connected to a video-out port of the storage device. The computer device may include a bidirectional interface providing a socketed connection to the storage device. The computer device may include at least one processor coupled to the memory. The at least one processor may be configured to request at least a portion of the file from the storage device via the socketed connection. The at least one processor may be configured to receive, via the video-in port, a plurality of video frames. The at least one processor may be configured to convert each of the video frames to a bitmap image including a header portion and a data portion. The at least one processor may be configured to reconstruct the requested at least a portion of the file based on the data portion of each bitmap image according to the header portions.

Additional advantages and novel features relating to implementations of the present disclosure will be set forth in part in the description that follows, and in part will become more apparent to those skilled in the art upon examination of the following or upon learning by practice thereof.

### DESCRIPTION OF THE FIGURES

In the drawings:

FIG. 1 is a diagram of an example computer system for transferring a data file from a computer device via a video interface in accordance with an implementation of the present disclosure;

FIG. 2 is a diagram of an example computer system for transferring a data file from a storage device via a video interface in accordance with an implementation of the present disclosure;

FIG. 3 is a conceptual diagram of a data file being converted to a plurality of frames in accordance with an implementation of the present disclosure;

FIG. 4 is a flowchart of an example method of transferring a data file from a computer device via a video interface in accordance with an implementation of the present disclosure;

FIG. 5 is a flowchart of an example method of receiving a data file from a computer device via a video interface in accordance with an implementation of the present disclosure;

FIG. 6 is a flowchart of an example method of providing access to a data file from a storage device via a video interface in accordance with an implementation of the present disclosure; and

FIG. 7 is a schematic block diagram of an example computer device in accordance with an implementation of the present disclosure.

### DETAILED DESCRIPTION

The present disclosure relates to file storage and transfer, and more particularly, to file transfer using a video port. Current solutions for transferring large files include network connections and universal serial bus (USB) connections. Maximum file transfer speeds for these connections are approximately 1 gigabit per second (gbps) or 125 MB/s. Accordingly, transfer of a 100 GB file may take approximately 10 minutes. Further, although newer versions of USB are becoming available, such connections may not be available on existing systems.

In an example use case, users of a video game console may desire fast file transfer speeds for loading games onto the console. Some games may be distributed over the Internet and downloaded by the user onto the game console. For users having a low bandwidth home Internet connection or a monthly data volume cap, downloading large video game files may not be a desirable option. Additionally, storage on a console may be limited, so there may be a need to download a game multiple times if storage has reached capacity. Therefore, there is a need in the art for improvements in file storage and file transfer between computer devices.

The present disclosure provides systems and methods for transferring a computer file via a video interface such as High-Definition Multimedia Interface (HDMI). Video interfaces are traditionally used to display video on a display device as a series of frames having the same resolution at a specified frame rate. Typically, the display device is assumed to have minimal processing capabilities and to simply display the received frames on a screen. A video interface also presents a potential for quickly transferring data between two devices. Video includes a large amount of data. For example, 1080p high-definition video at a frame rate of 120 frames per second (fps) may send data at a rate of 746 megabytes/second. Newer HDMI versions may support higher video resolutions of 4k at 120 fps to 10k at 120 fps. These video rates may translate to a data rate of 48 gigabits/second (6 gigabytes/second).

In an implementation, a video-in port is available on a device such as a video game console. For example, an XboxOne® game console from MICROSOFT includes an HDMI-in port that may be used to receive video from a source such as a cable box or satellite receiver. The received video may be relayed with or without modification to an HDMI-out port for display. Other example devices that include video-in ports include video capture cards, cable boxes, and televisions. The use of a video-in port for file transfer according to the present disclosure may provide such devices with higher speed access to data files than existing ports available on the device.

In an implementation, for example, this disclosure provides systems and methods for transferring a data file from a first device with a video-out port to a second device with a video-in port. Generally, the video-out port is associated with a graphics processing unit (GPU) that does not provide direct control over the video-out port. Instead, a driver for the GPU may provide an API with a limited set of functions. For example, the GPU is configured to render images according to a resolution and frame rate of a display device. In an implementation, a CPU may generate a plurality of bitmap images based on the file. Each bitmap image may include at least a portion of the data file and header information for the portion of the data file. The portion of the data file may be raw bits of a chunk of the data file stored as pixels of the bitmap image. The portion of the data file may also be compressed bits from one or more chunks of the data file stored as pixels of the bitmap image. The header information may be generated based on the data portion and stored as pixels of the bitmap image. Accordingly, the file data stored in the bitmap image may appear as noise is the bitmap image is displayed. The CPU may then instruct the GPU to scan the bitmap images as frames to a video-out port. Accordingly, the techniques disclosed herein may be used with various GPUs without requiring customization to the video-out port or the driver.

In another implementation, a storage device may include pre-computed bitmap images that may be scanned as frames to a video-out port. Each pre-computed bitmap image may include at least a portion of a file and header information for the portion of the file. The header information may allow the receiving device to perform integrity checking on the received bitmap images and reassemble the data file from multiple bitmap images. If a bitmap image is missing or becomes corrupted, the header information from another bitmap may be used to determine an identifier of the missing bitmap. The storage device may provide a specific bitmap when requested. In an implementation, the storage device may be able to transfer data to the memory of the receiving device at a faster rate than a traditional hard drive. In the case of a video game console, the storage device may reduce video game load time. Additionally, the storage device may include a network interface and/or serial bus that may be used to download a data file in the form of bitmap images to the storage device.

In an implementation, the receiving device may reconstruct a data file from a plurality of frames received on a video-in port. For example, the plurality of frames may be sent by either a computer generating the bitmap images based on the file or a storage device storing the pre-computed bitmap images. The receiving device may pull the data file from the source by sending requests for all or part of the data file or may receive a data file pushed from the source. The receiving device may convert each received frame to a bitmap image. The receiving device may perform integrity checks on the bitmap image to determine whether the bitmap image was received correctly. The receiving device may reassemble a data file from the bitmap images according to headers included in each bitmap image.

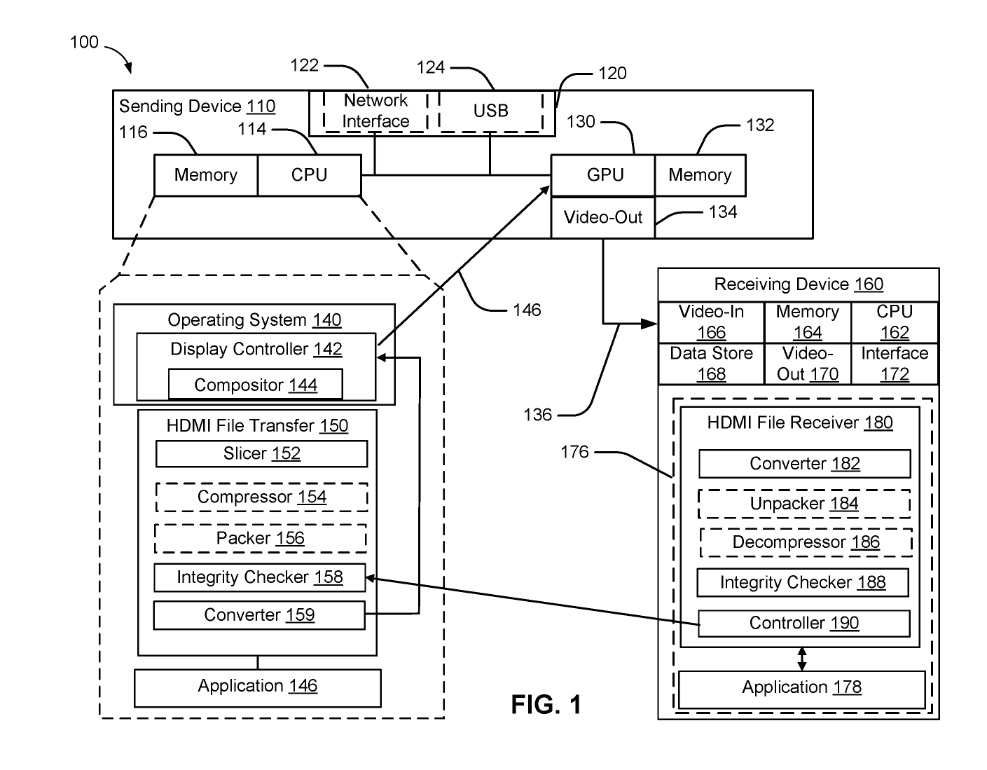

Referring now to FIG. 1, an example computer system 100 includes a sending computer device 110 and a receiving computer device 160. The sending computer device 110 may be, for example, any mobile or fixed computer device including but not limited to a desktop or laptop or tablet computer, a cellular telephone, a gaming device, a mixed reality or virtual reality device, a music device, a television, a navigation system, a camera, a personal digital assistant (PDA), a handheld device, any other computer device having wired and/or wireless connection capability with one or more other devices, or any other type of computerized device capable of generating a video-out signal. Similarly, the receiving computer device 160 may be, for example, any mobile or fixed computer device including but not limited to a desktop or laptop or tablet computer, a cellular telephone, a gaming device, a mixed reality or virtual reality device, a music device, a television, a navigation system, a camera, a personal digital assistant (PDA), a handheld device, any other computer device having wired and/or wireless connection capability with one or more other devices, or any other type of computerized device capable of receiving a video-in signal.

The sending computer device 110 may include a CPU 114 that executes instructions stored in memory 116. For example, the CPU 114 may execute an operating system 140 and one or more applications 146 including an HDMI File Transfer function 150. The computer device 110 may also include a GPU 130 for rendering frames, which may be presented via a video-out port 134, which may, for example, be an HDMI port or a DisplayPort port. The operating system 140 may control the GPU 130 to render bitmap images representing a file as frames to the video-out port 134.

Memory 116 may be configured for storing data and/or computer-executable instructions defining and/or associated with an operating system 140 and/or application 146, and CPU 114 may execute operating system 140 and/or application 146. An example of memory 116 can include, but is not limited to, a type of memory usable by a computer, such as random access memory (RAM), read only memory (ROM), tapes, magnetic discs, optical discs, volatile memory, non-volatile memory, and any combination thereof. Memory 116 may store local versions of applications being executed by CPU 114.

The CPU 114 may include one or more processors for executing instructions. An example of CPU 114 can include, but is not limited to, any processor specially programmed as described herein, including a controller, microcontroller, application specific integrated circuit (ASIC), field programmable gate array (FPGA), system on chip (SoC), or other programmable logic or state machine. The CPU 114 may include other processing components such as an arithmetic logic unit (ALU), registers, and a control unit. The CPU 114 may include multiple cores and may be able to process different sets of instructions and/or data concurrently using the multiple cores to execute multiple threads.

The operating system 140 may include instructions (such as application 146) stored in memory 116 and executable by the CPU 114. The operating system 140 may include a display controller 142 for controlling the GPU 130. For example, the display controller 142 may provide commands to the GPU 130 to perform one or more specific graphics processing operations such as rendering a frame based on a bitmap. The display controller 142 may include a compositor 144, in the form of a hardware and/or software component, configured to combine multiple sources of information to create a complete image for display. For example, in a 2D environment, the compositor 144 may determine in which windows various applications are to be rendered. In an implementation, bitmaps for the HDMI file transfer function 150 may be presented in a full-screen mode to bypass the compositor 144.

The GPU 130 may include one or more processors and/or specialized hardware for image processing. In an implementation, the GPU 130 may be integrated with a CPU 114 on a motherboard of the computer device or may be a discrete chip. The GPU 130 may include a dedicated memory 132. The GPU 130 or sending computer device 110 may include a video-out port 134. The GPU 130 may periodically scan out an image from the memory 132 to the video-out port 134 according to a refresh rate. For example, the dedicated memory 132 may store a buffer including the next bitmap image to be scanned to the video-out port 134. The GPU 130 may output the bitmap image as a display frame via the video-out port to the receiving computer device 160.

The video-out port 134 may be a digital output port typically used for connecting the sending computer device 110 to a display device such as a computer monitor or television. For example, the video-out port 134 may be a High-Definition Multimedia Interface (HDMI) port. An HDMI port is a common video interface available on PCs, video game consoles, and other devices that process or display video. Accordingly, in an implementation, existing video hardware may be repurposed for transferring files. As another example, the video-out port 134 may be a DisplayPort port. A DisplayPort port may be electrically compatible with HDMI and may be converted to an HDMI signal with a passive converter. The video-out port 134 may be connected to a video-in port 166 of the receiving device 160 using a video cable 136. The video cable 136 may establish a unidirectional video channel from the video-out port 134 to the video-in port 166. In an implementation, the video-out port 134, the video cable 136, and the video-in port 166 may provide a bidirectional socketed channel in addition to the video channel. For example, some implementations of HDMI include a HDMI Ethernet Channel (HEC) or an HDMI Ethernet and Audio Return Channel (HEAC).

The computer device 110 may also include one or more additional interface(s) 120 that provide(s) a bidirectional channel that may be used to establish a socketed connection. For example, the computer device 110 may optionally include a network interface 122, which may include any wired or wireless network interface (e.g., Ethernet or Wi-Fi). As another example, computer device 110 may optionally include a universal serial bus (USB) interface 124. The interface 120 of computer device 110 may be connected to a corresponding interface 172 of receiving device 160.

The computer device 110 may include an HDMI file transfer function 150. The HDMI file transfer function 150 may be an application executed by the CPU 114. In an implementation, the HDMI file transfer function 150 may be a function of the operating system 140. The HDMI file transfer function 150 may be configured to generate bitmap images based on a data file and instruct the GPU 130 to scan the bitmap images to the video-out port 134. The HDMI file transfer function 150 may include a slicer 152 for dividing the data file into multiple chunks, a compressor 154 for compressing the size of chunks, a packer 156 for packing multiple compressed chunks into a bitmap image, an integrity checker 158 for generating checksums, and a converter 159 for converting a chunk into a bitmap image.

The slicer 152 may divide a data file into multiple chunks. A chunk may be a block of data that fits within a frame. The frame size may be based on a selected display mode. For example, display modes may include 1080p at 30 fps, 4k at 120 fps, 8k at 60 fps, or any other combination of resolution and refresh rate supported by the GPU 130 and video-out port 134. In particular, the frame size may be the size of a bitmap image at the resolution, intensity, and color settings of the display mode. A chunk may be smaller than the frame size to allow for header information, which may be relatively small (e.g., less than 1%). The header information may include information for checking the integrity of a received bitmap image (e.g., a checksum) and information for reassembling a data file (e.g., sequence identifiers). In an implementation where compression is used, a smaller chunk size may be selected to provide efficiency in packing.

The compressor 154 may optionally compress chunks into compressed chunks. The compressor 154 may be used when compression is expected to improve total throughput. For example, where a data file is uncompressed, compressing the chunks may reduce the total amount of data to be transmitted via the video-out port and result in a faster file transfer. On the other hand, if the data file is already compressed or compression does not yield significant improvement, the compressor 154 may not be used. For example, a commercially distributed video game file may be compressed whereas a video game file under development may not be compressed. The compressor 154 may apply a lossless compression algorithm to the chunks. In an implementation, the compressor 154 may use multiple threads to compress multiple chunks concurrently. The multiple threads may allow the CPU 114 to perform the compression at a rate that keeps up with the data rate of the video-out port 134. The number of threads utilized by the compressor 154 may be selected based on characteristics of the CPU 114 (e.g., number of cores) or may be selected by a user. The output size of the compressed chunks may depend on the input data and may result in compressed chunks of varying size.

The packer 156 may optionally pack compressed chunks into a bitmap-sized package. The packer 156 may generate header information indicating the contents of the package. For example, the package header information may include an identifier of each chunk and/or identifiers of contents of the chunk. The package header portion may also include information regarding the number and boundaries of the compressed chunks. The package header information for unpacking the compressed chunks may be included in the header portion of the bitmap image or as a package header within the data portion. In some cases, the identifier may include or may additionally indicate a sequence number of the package, and/or of chunks and/or bitmap image data within the package, e.g., when the package includes some subset of chunks of a sliced data file. The packer 156 may also pad the package to generate a correctly sized chunk.

The integrity checker 158 may generate a checksum based on the chunk. The integrity checker 158 may use a checksum algorithm selected to allow a determination of whether the chunk becomes corrupted during transmission. The integrity checker 158 does not necessarily provide error correction based on the checksum as it may be more efficient to retransmit a corrupted chunk. The integrity checker 158 may be applied to a raw chunk, a compressed chunk, or packaged compressed chunks. The integrity checker 158 may also receive feedback indicating whether transmitted bitmap images were correctly received at the receiving device 160. For example, the integrity checker 158 may receive an acknowledgment via the network interface 122 or the USB interface 124. The acknowledgment may indicate a receipt status of one or more bitmap images using the identifier(s) included in the header information. The integrity checker 158 may determine that a bitmap image was not correctly received based on the acknowledgement. The integrity checker 158 may retransmit a bitmap image that was not correctly received.

The converter 159 may convert the chunk and header information to a bitmap image. For example, the converter 159 may ensure that the data of the chunk and header is the correct size. The converter 159 may copy the bitmap image into a buffer to be provided to the GPU 130. The converter 159 may also instruct the display controller 142 and/or the GPU 130 to render the bitmap image as a frame. In an implementation, the converter 159 may instruct the GPU 130 to render the bitmap image in a manner that does not alter the bitmap image. For example, the converter 159 may instruct the bitmap image to be rendered in full-screen mode to prevent compositor 154 or any other application from overwriting a portion of the bitmap image. The converter 159 may also instruct the GPU 130 to slave the scanning of the bitmap image to a V-SYNC. Accordingly, the GPU 130 may wait until the entire bitmap image is loaded into a display buffer of memory 132 before beginning to scan the image in order to prevent tearing of the image. If a new bitmap image is not available in the display buffer of memory 132, a previous frame may be presented again, which may allow the receiving device 160 to discard the duplicate frame.

In an implementation, the receiving device 160 may be similar to the computer device 110. For example, both the receiving device 160 and the computer device 110 may be PCs. In another example implementation, the receiving device 160 may be a video game console, which may include similar components to a PC. The receiving device 160 may include a CPU 162 that executes instructions stored in memory 164. For example, the CPU 162 may execute an operating system 176 and an HDMI File receiver function 180. The receiving device 160 may include a video-in port 166, which may, for example, be an HDMI port or a DisplayPort port. The receiving device 160 may also include a video-out port 170, which may be another HDMI port or DisplayPort port. Conventionally, the video-in port 166 may receive a video signal from a video source such as a cable box, which may be relayed to the video-out port 170 for display on a display device. In an implementation of the current disclosure, the HDMI File Receiver function 180 may obtain frames received on the video-in port 166 and reassemble a data file based on bitmap images included in the received frames. The received file may be provided to the memory 164 (e.g., for execution) or to a data store 168 for later access.

Memory 164 may be configured for storing data and/or computer-executable instructions defining and/or associated with an operating system 176 and/or applications 178, and CPU 162 may execute operating system 176 and/or applications 178. An example of memory 164 can include, but is not limited to, a type of memory usable by a computer, such as random access memory (RAM), read only memory (ROM), tapes, magnetic discs, optical discs, volatile memory, non-volatile memory, and any combination thereof. Memory 164 may store local versions of applications being executed by CPU 162.

The CPU 162 may include one or more processors for executing instructions. An example of CPU 162 can include, but is not limited to, any processor specially programmed as described herein, including a controller, microcontroller, application specific integrated circuit (ASIC), field programmable gate array (FPGA), system on chip (SoC), or other programmable logic or state machine. The CPU 162 may include other processing components such as an arithmetic logic unit (ALU), registers, and a control unit. The CPU 162 may include multiple cores and may be able to process different sets of instructions and/or data concurrently using the multiple cores to execute multiple threads.

The receiving device 160 may also include a second bidirectional interface 172. The bidirectional interface 172 may be used to establish a socketed connection with the sending computer device 110. In an implementation, the bidirectional interface 172 may include an HEC or HEAC channel implemented on the video-in port 166. In other implementations, the bidirectional interface 172 may include a network interface or USB interface, which may be connected to network interface 122 or USB interface 124 of the sending computer device 110.

The operating system 176 may include instructions (such as HDMI File Receiver function 180 and application 178) stored in memory 164 and executable by the CPU 162. The operating system 176 may include a driver for controlling video-in port 166. In an implementation, the driver for controlling video-in port 166 may provide lower level access that may not be available on all video-in ports. For example, the driver for the video-in port 166 may implement an Ethernet connection or other socketed connection over the video cable 136. The operating system 176 may also provide the HDMI file receiver function 180 with access to frames received via the video-in port 166. The operating system 176 may also manage files reconstructed by the HDMI file receiver function 180.

The HDMI File Receiver function 180 may operate in conjunction with the HDMI file transfer 150 to transfer a file from the sending computer device 110 to the receiving device 160. The HDMI file receiver function 180 may perform inverse operations to the HDMI file transfer function 150 to reconstruct a data file from received video frames. The HDMI file receiver function 180 may include a converter 182 for converting received video frames to bitmap images, an optional unpacker 184 for extracting compressed chunks from a bitmap image, an optional decompressor 186 for decompressing compressed chunks, an integrity checker 188 for checking the integrity of received bitmap images or chunks, and a controller function 190 for requesting bitmap images and providing an acknowledgment to the computer device 110 indicating whether a bitmap image was successfully received.

The converter 182 may convert a received video frame to a bitmap image, and then convert the bitmap image into a data portion and header portion. For example, the converter 182 may load the received video frame into a buffer to convert the video frame to the bitmap image. The converter 182 may identify the header portion and chunk portion within the bitmap image based on configured parameters. For example, the header may have a fixed size and position. Alternatively, the size and position may be indicated by previous header information or via the second socketed channel.

The unpacker 184 may optionally unpack compressed chunks from a bitmap-sized package within the data portion. The header portion of the bitmap image may indicate whether the chunk includes compressed chunks. The header portion may also include information regarding the number and boundaries of the compressed chunks. Alternatively the information for unpacking the compressed chunks may be included as a package header within the data portion. The unpacker 184 may generate a plurality of compressed chunks.

The decompressor 186 may optionally decompress compressed chunks. The decompressor 186 may apply a decompression algorithm that is an inverse of the compression algorithm used by compressor 154. The decompressor 186 may generate a plurality of chunks that are uniform in size, even though the compressed chunks may be different sizes.

The integrity checker 188 may determine whether a bitmap image, chunk, or compressed chunk was correctly received. For example, the integrity checker 188 may determine a checksum for a received bitmap image, chunk, or compressed chunk, and compare the determined checksum to a checksum received in the header information. The integrity checker 188 may use the same checksum algorithm selected by the integrity checker 158. In one non-limiting example, if the bitmap image is correctly received, each of the checksums should have the same value. If the checksums do not have the same value, the integrity checker 188 may determine that the bitmap image has been corrupted during transfer (e.g., due to tearing at the GPU 130 or due to noise on the video cable).

The controller function 190 may provide an acknowledgement to sending computer device 110 indicating whether one or more bitmap images were successfully received. The controller function 190 may provide the acknowledgement via a socketed connection, which may utilize, for example, the bidirectional interface 172. The acknowledgment may provide a reception status of one or more bitmap images. For received bitmap images, the status may be determined by the integrity checker 188. The receiving device 160 may also determine whether any bitmap images are missing based on the header information. For example, if a bitmap image identifier is missing from a sequence of bitmap images, e.g., based on a missing sequence number or identifier, the controller function 190 may include the identifier of the missing bitmap image in the acknowledgement.

In another implementation, data access may be driven by the receiving device 160 and the controller function 190 may request specific bitmap images corresponding to a portion of a data file. The controller function 190 may map a request (e.g., from application 178) for a file or portion thereof to a bitmap image identifier. The controller function 190 may send the request to the sending computer device 110 via the socketed connection.

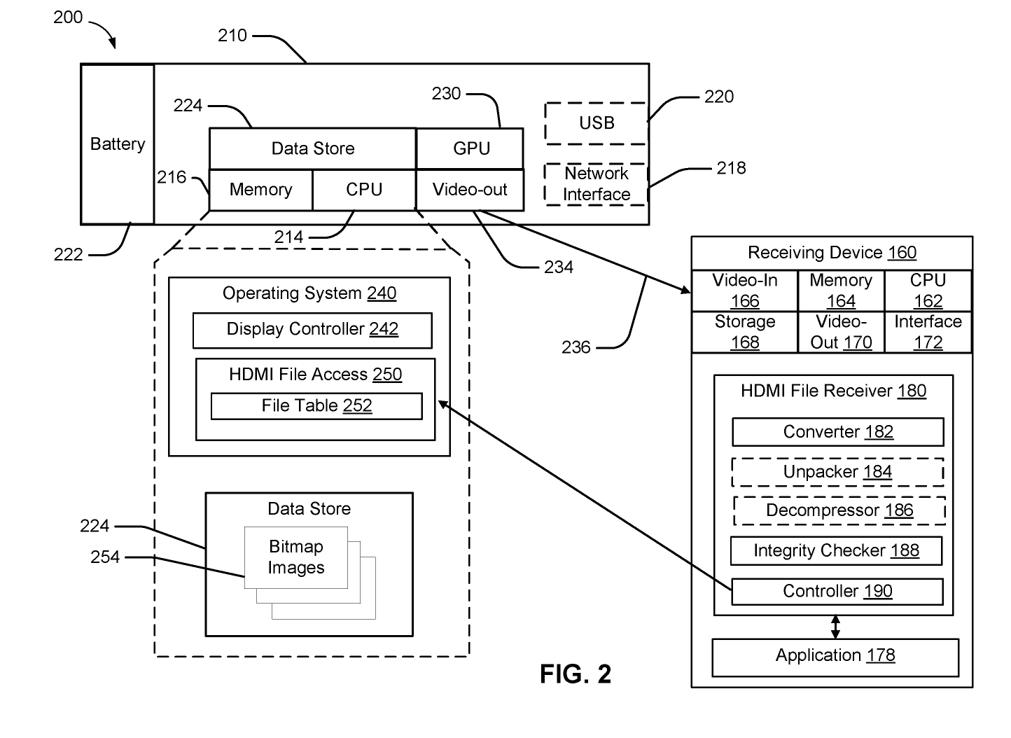

Referring now to FIG. 2, an example computer system 200 includes a storage device 210 that may be used with the receiving device 160. The storage device 210 may include a data store 224 storing bitmap images 254 representing portions of a data file. Each bitmap image 254 may include at least a portion of the file and header information for the portion of the file. The bitmap images 254 may be the same as the bitmap images generated by the computer device 110. Instead of generating the bitmap images from a data file, the storage device 210 may store the pre-computed bitmap images 254 to provide a relatively fast storage device (e.g., compared to a storage device using only a bidirectional interface) for providing access to a data file via a video-in port 166. For example, the storage device 210 may be connected to a video-in port 166 of the receiving device 160, which may be a video game console, to allow high-speed access to a stored video game. The stored video game may be transferred to an internal data store 168 of the receiving device 160 or may be accessed as needed to load and play the video game on the receiving device 160.

The storage device 210 may include a CPU 214 that executes instructions stored in memory 216. For example, the CPU 214 may execute an operating system 240 and an HDMI File Access function 250. The storage device 210 may also include a GPU 230 for scanning bitmap images, which may be presented via a video-out port 234, which may be similar to the video-out port 134. The operating system 240 may control the GPU 230 to render bitmap images representing a file as frames to the video-out port 234. The storage device 210 may include a data store 224 storing the bitmap images 254. The storage device 210 may also optionally include a bidirectional interface 172 such as a network interface and/or a USB port for providing a socketed communication channel. The storage device 210 may also include a battery 222 and/or power supply (not shown).

Memory 216 may be configured for storing data and/or computer-executable instructions defining and/or associated with an operating system 240, and CPU 114 may execute operating system 240. An example of memory 216 can include, but is not limited to, a type of memory usable by a computer, such as random access memory (RAM), read only memory (ROM), tapes, magnetic discs, optical discs, volatile memory, non-volatile memory, and any combination thereof.

The CPU 214 may include one or more processors for executing instructions. An example of CPU 214 can include, but is not limited to, any processor specially programmed as described herein, including a controller, microcontroller, application specific integrated circuit (ASIC), field programmable gate array (FPGA), system on chip (SoC), or other programmable logic or state machine. The CPU 214 may include other processing components such as an arithmetic logic unit (ALU), registers, and a control unit. In an implementation, the CPU 214 may be relatively less powerful and expensive than the CPU 114. For example, as described in further detail below, the CPU 114 may not need to perform slicing and compression of a data file.

The data store 224 may be a mass storage device such as a hard drive, solid state drive, read-only memory, or electronically-erasable programmable read-only memory (EEPROM). In an implementation, the data store 224 may be selected to have a file access speed compatible with a data rate of the video-out port 234. For example, the data store 224 may be an embedded multi-media card (eMMC).

The operating system 240 may include instructions (such as HDMI File Access function 250) stored in memory 216 and executable by the CPU 214. The operating system 240 may include a display controller 242 for controlling the GPU 230. For example, the display controller 242 may provide commands to the GPU 230 to perform one or more specific graphics processing operations such as rendering a frame based on a bitmap. Accordingly, the HDMI file access function 250 may operate in a similar manner as the converter 159 to display the bitmap images. In an implementation, the CPU 214 may have direct control over the GPU 230, for example, using a customized driver. For example, the CPU 214 may not be limited to predefined functions of the GPU 230 for displaying a bitmap image. Instead, the CPU 214 may directly copy the bitmap image into a display buffer associated with GPU 230 or point the GPU 230 to an existing buffer including a bitmap image. The CPU 214 may order the GPU 230 to display the contents of the buffer as a frame.

The GPU 230 may include one or more processors and/or specialized hardware for image processing. In an implementation, the GPU 230 may be integrated with a CPU 214 on a motherboard of the storage device 210 or may be a discrete chip. The GPU 230 may include a video-out port 234, which may be similar to the video-out port 134. The GPU 230 may periodically scan out an image from the memory 216 to the video-out port 234 according to a refresh rate. For example, the memory 216 may store a buffer including the next bitmap image to be scanned to the video-out port 234. In an implementation, the GPU 230 may be relatively simple and inexpensive hardware that converts the frame buffer into an HDMI signal.

The HDMI File Access function 250 may emulate a mass storage device such as a USB mass storage device, hard drive, CD-ROM, or Blu-ray disk. The HDMI file access function 250 may receive data access requests from the controller function 190. The HDMI file access function 250 may retrieve the requested data in the form of bitmap images scanned as frames to the video-out port 234, which may be connected to the video-in port 166 via a video cable 236. The HDMI file access function 250 may include a file table 252. The file table 252 may include a mapping of file locations to bitmap image identifiers. When the HDMI file access function 250 receives a request for a data file or portion thereof, the file table 252 may translate the requested file or portion into one or more bitmap image identifiers. The HDMI file access function 250 may then read the bitmap image identifiers from data store 224 and provide the bitmap images 254 to GPU 230 for scanning out via video-out port 234.

The storage device 210 may be a portable electronic device. In an implementation, the video-in port 166 does not provide sufficient power to operate storage device 210. The storage device 210 may be powered by the battery 222. The battery 222 may be any battery for powering portable computer devices. For example, the battery 222 may be but is not limited to a lithium-ion battery. The battery 222 may be connected to a power source such as an AC/DC converter or battery charger.

The storage device 210 may also be operated when not connected to another device via a video cable. For example, the storage device 210 may connect to a wireless network and download pre-computed bitmap images 254 for later transfer to a receiving device 160. This feature may be useful in the case of a low speed home Internet connection. The bitmap images 254 may be downloaded via a faster network such as a Wi-Fi hotspot provided by a business. In another implementation, the bitmap images 254 may be loaded to the storage device 210 via the USB port 220.

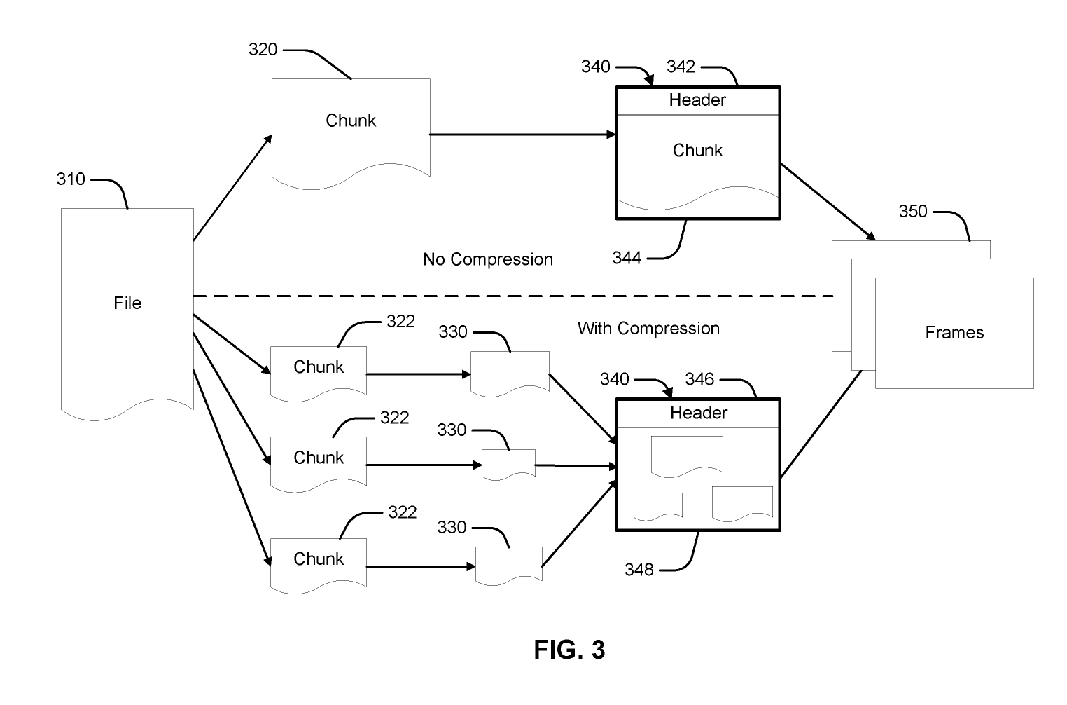

Referring now to FIG. 3, a conceptual diagram 300 illustrates conversion of a file 310 into multiple frames 350 with and without compression. The file 310 may be any data file capable of being stored on a computer. For example, the file 310 may be a video game, application, media file, data set, or a collection of smaller files. The file 310 may be stored in a data store of the sending device 110.

The data file 310 may be divided into chunks 320 or smaller (e.g., in terms of file memory size) chunks 322. The chunks 320, 322 may be raw bits from the data file 310 regardless of any internal structure of the data file 310. The size of the chunks may be based on a resolution of the frames 350. For example, if the frames 350 are 1080p frames using uncompressed RGB 24-bit format, each frame may carry 6.2 MB. Part of the frame, however, may be used for a header portion 342. Accordingly, when compression is not used, the size of chunk 320 may be selected to be, for example, approximately 6 MB so that the chunk 320 fills most of the frame while providing room for a header portion 342. In an implementation, the size of the chunk 320 and the header portion 342 may be selected to completely fill a frame 350. The header portion 342 may be generated based on the chunk 320. The header portion 342 may include, for example, file information such as the number of chunks in the file 310, the size of the chunks 320, an identifier of the chunk 320, and checksums for performing integrity checking. The header portion 342 may be concatenated with the chunk 320 to generate a bitmap image 340. The bitmap image 340 may include the header portion 342 and a data portion 344, which may be the chunk 320. The bitmap image 340 may be a series of pixels, each represented by a number of bits (e.g., 24 bits in RGB 24-bit format). Instead of storing image data, however, the bitmap image 340 may include the bits for the header information in the header portion 342 and the raw bits from the data file 310 (e.g., a number of bits equal to the chunk size) in the data portion 344. The GPU 130 may convert the bitmap image 340 to a frame by scanning the bitmap image to the video-out port without alteration. For example, the bitmap image 340 may be scanned as a stream of lines. It should be appreciated that since the bitmap image 340 includes file data rather than image data, if viewed on a display, the frames 350 may appear as random noise.

When compression is used, the file 310 may be divided into smaller chunks 322, which are compressed into even smaller compressed chunks 330 and packed into data portion 348 of a bitmap image 340. The size of compressed chunk 330 may be unknown in advance due to the nature of lossless compression and the compressibility of each smaller chunk 322. The size of the smaller chunks 322 may be selected such that multiple compressed chunks 330 may fit within a frame 350. Additionally, the size of the smaller chunks 322 may be selected based on the compression process or processing load. For example, the size of the smaller chunks 322 may be selected to optimize efficiency of a compression algorithm. When the smaller chunks 322 are compressed, the compressed chunks 330 may be various sizes. The compressed chunks 330 may be packed within a data portion 348 of the bitmap image 340. For example, a number of compressed chunks that fit within the data portion 348 may be selected and the rest of the data portion 348 may be padded. Accordingly, the pixels of the data portion 348 may include the bits of the compressed chunks and padding bits. The header portion 346 may include the same information as the header portion 342. The header portion 346 may also include information regarding the packing of compressed chunks within the data portion 348. Accordingly, the header portion 346 may be larger than the header portion 342 and the data portion 348 may be smaller than the data portion 344 for the same resolution of frame 350. Therefore, using compression may trade off greater overhead of the header portion 346 in exchange for the potential of a higher data rate of the compressed chunks. The sending device 110 may determine whether to use compression based on the compressibility of a data file. As with uncompressed chunks, it should be appreciated that since the bitmap image 340 includes compressed file data rather than image data, if viewed on a display, the frames 350 may appear as random noise.

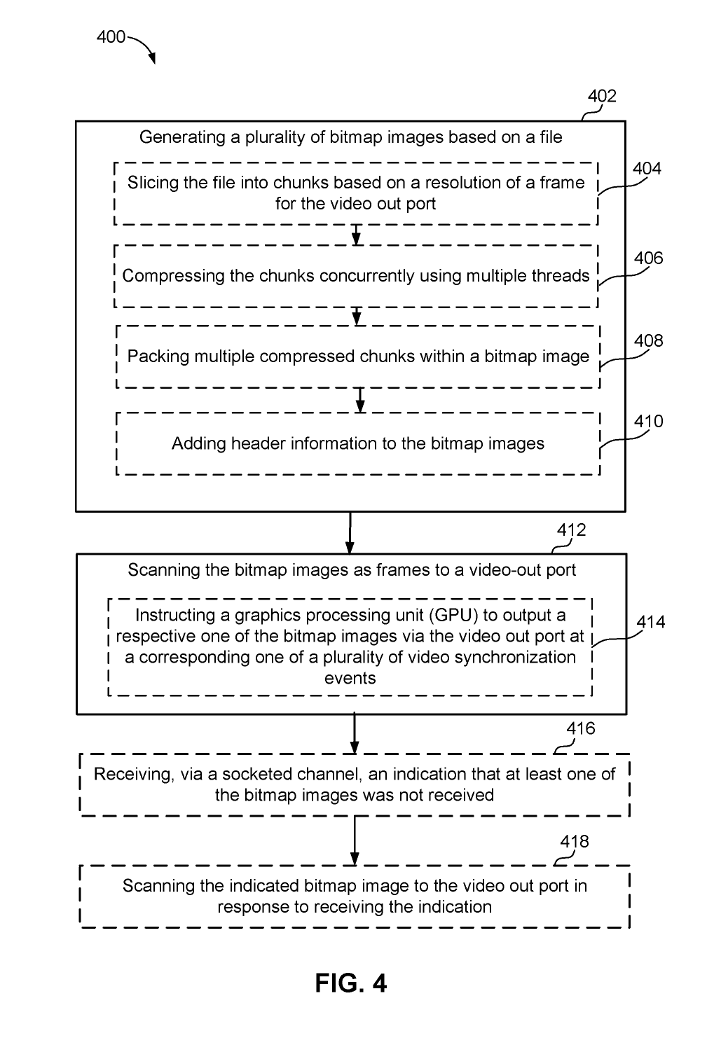

Referring now to FIG. 4, an example method 400 provides for transferring a data file via a video-out port. For example, method 400 may be performed by the sending computer device 110.

At 402, the method 400 may include generating a plurality of bitmap images based on a file. For example, the HDMI file transfer function 150 may generate a plurality of bitmap images based on the file. For instance, HDMI file transfer function 150 may include an algorithm or function to receive a data file and generate multiple BMP format files or raster images (e.g., any digital image with dimensions given in units of pixels) in any format. Optional actions 404, 406, 408, and 410 provide an example algorithm. Each bitmap image may include a data portion including a portion of data of the file and a header portion.

At 404, the action 402 may optionally include slicing the file into chunks based on a resolution of a frame for the video-out port. For example, the slicer 152 may slice the file 310 into chunks 320, 322 based on the resolution of a frame 350 for the video-out port 134. The resolution of a frame 350 for the video-out port 134 may be based on a display mode. The display mode may be selected to maximize the data rate for sending the file based on the hardware capabilities of the sending computer device 110 and the receiving computer device 160. For example, the display mode having the highest resolution and frame rate that both of the devices can handle may be selected. As discussed above with respect to FIG. 3, the chunk size may be a percentage of the number of bits carried by a frame. The percentage may depend on whether compression is to be used. The slicer 152 may divide the file into even sized chunks 320, 322 of the chunk size. A final chunk may be padded.

At 406, the action 402 may optionally include compressing the chunks. For example, the compressor 154 may compress the chunks 322 into compressed chunks 330. The compressor 154 may use a lossless compression algorithm so that data from the data file is not lost. The HDMI file transfer function 150 may determine whether to perform compression based on the compressibility of the file 310. For example, if the file 310 has already been compressed, further compression of the chunks 322 is unlikely to increase a file transfer speed. In an implementation, the action 406 may use multiple threads to compress the chunks. For example, each chunk may be compressed by a different thread executing on a different processor core. Using multiple-threads may allow the compression to keep up with a data rate of the file transfer.

At 408, the action 402 may optionally include packing multiple compressed chunks within a bitmap image. For example, the packer 156 may pack multiple compressed chunks 330 within a data portion 348 of a bitmap image 340. The packer 156 may select compressed chunks 330 that will fit within the bitmap image. For example, if a next sequential compressed chunk 330 is too large to fit within the bitmap image 340, the packer 156 may select a smaller compressed chunk 330 or may pad the remaining space within the bitmap.

At 410, the action 402 may optionally include adding header information to the bitmap images. For example, the integrity checker 158 may add the header portion 342, 346 to the bitmap images 340. The header portion 342 may include a checksum for the data portion 344 and an identifier of the chunk 320. In an implementation, the header portion 342 may also include information such as the total number of chunks, range of identifiers, or other information regarding the file 310. Although such information may be redundant when included in every bitmap, the size of such information may be relatively small compared to the size of a chunk 320. When compression is used, the header portion 346 may include information regarding packing. For example, in addition to the information in the header portion 342, the header portion 346 may include the identifiers of each of the chunks 322 as well as locations of each compressed chunk 330 within the data portion 348.

At 412, the method 400 may include scanning the bitmap images as frames to a video-out port. For example, the converter 159 may scan the bitmap images as frames to the video-out port 134. In an implementation, the converter 159 may be unable to directly access the video-out port 134 and may utilize commands to the operating system 140 and/or GPU 130 to scan the bitmap images as frames.

At 414, the action 412 may optionally include instructing a GPU to display the bitmap images via the video port at a plurality of video synchronization events. For example, converter 159 may utilize MICROSOFT DirectX® to instruct the GPU 130. The converter 159 may load a bitmap image into a buffer in memory 116. The converter 159 may use a display command to have the display controller 142 display the bitmap image in a full-screen mode. Full-screen mode may bypass a 2D compositor and prevent any portion of the bitmap image from being altered. The display controller 142 may copy the bitmap image from the memory 116 to a display buffer in memory 132 associated with the GPU 130. The timing for displaying the bitmap images may be slaved to a video synchronization (V-SYNC) corresponding to a deadline for presenting a next frame. The use of the V-SYNC may avoid tearing the bitmap image, which would result in a corrupted bitmap image. At the V-SYNC, the GPU 130 may scan the bitmap image out to the video-out port 134 as a frame according to the display mode.

At 416, the method 400 may optionally include receiving, via a socketed channel, an indication that at least one of the bitmap images was not received. For example, the integrity checker 158 may receive, via a socketed connection over the network interface 122 or the USB interface 124, the indication that at least one of the bitmap images 340 was not received by the receiving device 160. The socketed channel may provide confirmation to both the sending device 110 and the receiving device 160 that indications are successfully received. The indication may, for example, be an acknowledgement that some of the bitmap images were received. The integrity checker 158 may determine that the acknowledgment does not include an identifier of a bitmap image that was scanned. In another example, the indication may include an identifier a bitmap image that did not pass an integrity check at the receiving device 160, or an identifier of a bitmap image that was not received in sequence with other bitmap images.

At 418, the method 400 may optionally include scanning the indicated bitmap image to the video-out port in response to receiving the indication. For example, the converter 159 may scan the indicated bitmap image to the video-out port 134 in response to receiving the image. The scanning in action 418 may be performed in the same manner as the scanning in action 412.

Thus, the operation of method 400 transfers a data file in the form of one or more bitmap images via a video-out port.

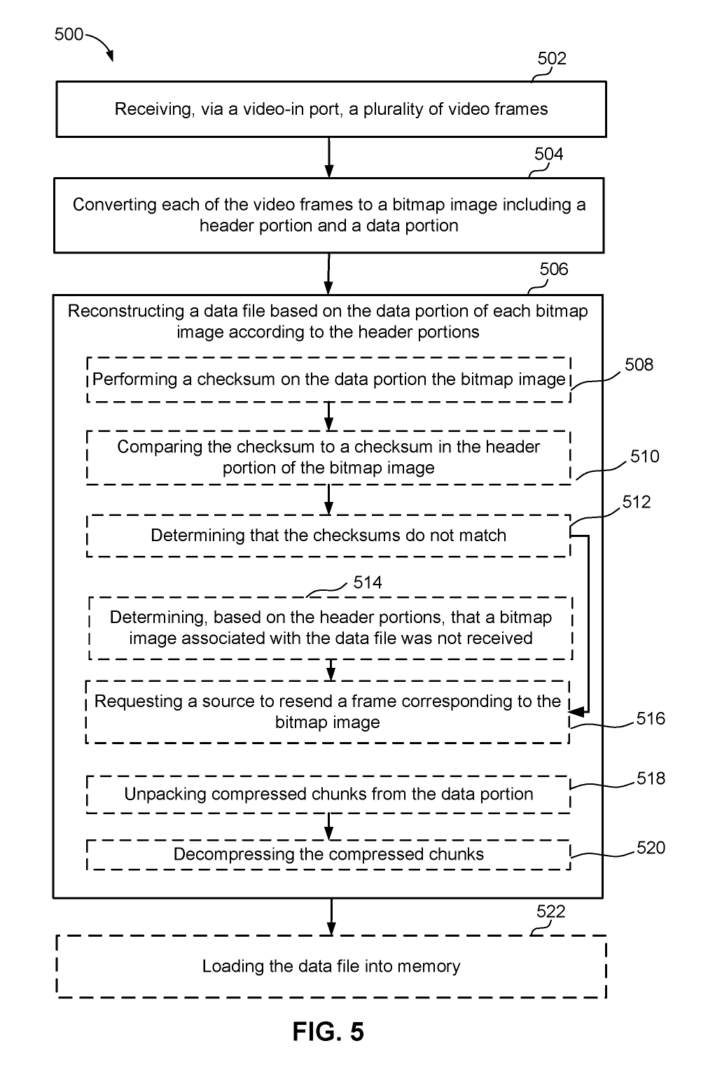

Referring now to FIG. 5, an example method 500 provides for receiving a data file via a video-in port. For example, method 500 may be performed by the receiving computer device 160.

At 502, the method 500 may include receiving, via a video-in port, a plurality of video frames. For example, the video-in port 166 may receive the plurality of video frames from the sending computer device 110 or the storage device 210 over a video cable. The video frames may be received according to a video mode. For example, the video frames may have a resolution and frame rate determined by the video mode.

At 504, the method 500 may include converting each of the video frames to a bitmap image including a header portion and a data portion. For example, the converter 182 may convert each of the video frames 350 to a bitmap image 340 including a header portion 342, 346 and a data portion 344, 348. For instance, converter 182 include an algorithm or function to receive video frames and generate multiple BMP format files or raster images (e.g., any digital image with dimensions given in units of pixels) in any format. The converter 182 may copy a video frame 350 from a received frame buffer to a memory 164. The converter 182 may determine the location of the header portion 342, 346 and the data portion 344, 348 based on configured bitmap properties, which may be received via a socketed connection over the bidirectional interface. For example, the end of the header portion or start of the data portion may be in a fixed location of the bitmap, or may be indicated (e.g., in a first byte of the bitmap) within each bitmap.

At 506, the method 600 may include reconstructing a data file based on the data portion of each bitmap image according to the header portions. For example, the HDMI file receiver function 180 may reconstruct the data file 310 based on the data portion 344, 348 of each bitmap image 340 according to the header portions 342, 346.

At 508, the action 506 may optionally include performing a checksum on the data portion the bitmap image. For example, the integrity checker 188 may perform the checksum on the data portion 344, 348 of each bitmap image 340. The integrity checker 188 may use the same checksum algorithm as the integrity checker 158 uses to generate the checksum in the header portion 342, 346. The checksum may be based on the entire data portion 344, 348. Accordingly, if the data portion 344, 348 is corrupted either during scanning or during transmission, the checksum based on the received data portion will be different than the checksum determined by the integrity checker 158.

At 510, the action 506 may optionally include comparing the determined checksum to a checksum in the header portion of the bitmap image. For example, the integrity checker 188 may compare the determined checksum to the checksum in the header to determine whether or not the values match, which indicates the information has been received correctly.

At 512, the action 506 may optionally include determining that the checksums do not match. For example, the integrity checker 188 may determine that the checksums do not match when they have different values.

At 514, the action 506 may optionally include determining, based on the header portions, that a bitmap image associated with the data file was not received. For example, the integrity checker 188 may determine, based on the header portions 342, 346, that a bitmap image 340 associated with the data file was not received. The integrity checker 188 may determine that a bitmap image was not received when none of the header portions 342, 346 include an expected identifier. For example, if the header portions 342, 346 indicate a number of bitmap images or a range of identifiers, and the number and identifiers of the received bitmap images do not match the indicated number and range, the integrity checker 188 may determine that a bitmap image is missing. The integrity checker 188 may also determine the identifier of the missing bitmap image.

At 516, the action 506 may include requesting a source to resend a frame corresponding to the bitmap image. For example, the controller function 190 may request the sending computer device 110 or the storage device 210 to resend a frame corresponding to the bitmap image. The controller function 190 may make the request in response to either action 512 or action 514. Accordingly, the controller function 190 may request bitmap images that either have become corrupted or are missing.

At 518, the action 506 may optionally include unpacking compressed chunks from the data portion. For example, the unpacker 184 may unpack compressed chunks 330 from the data portion 348. The unpacker 184 may use package header information to determine the start and end of each compressed chunk 330.

At 520, the action 506 may optionally include decompressing the compressed chunks. For example, the decompressor 186 may decompress the compressed chunks 330. The decompressor 186 may apply a decompression algorithm that is the inverse of the lossless compression algorithm applied by the compressor 154. Accordingly, the decompressor 186 may regenerate the original chunks 322 without alteration.

At 520, the method 500 may include loading the data file into memory. For example, the HDMI file receiver function 180 may load the data file 310 into memory 164. In an implementation, the data file 310 may be a video game. The HDMI file receiver function 180 may load the data file 310 directly into a memory such that the video game is playable. The HDMI file receiver function 180 may load the portions of the data file 310 that allow the game to be played. The HDMI file receiver function 180 may use the controller function 190 to request additional portions of the data file 310 or other data files as needed to play the game.

Thus, the operation of method 500 receives a data file in the form of one or more bitmap images via a video-in port.

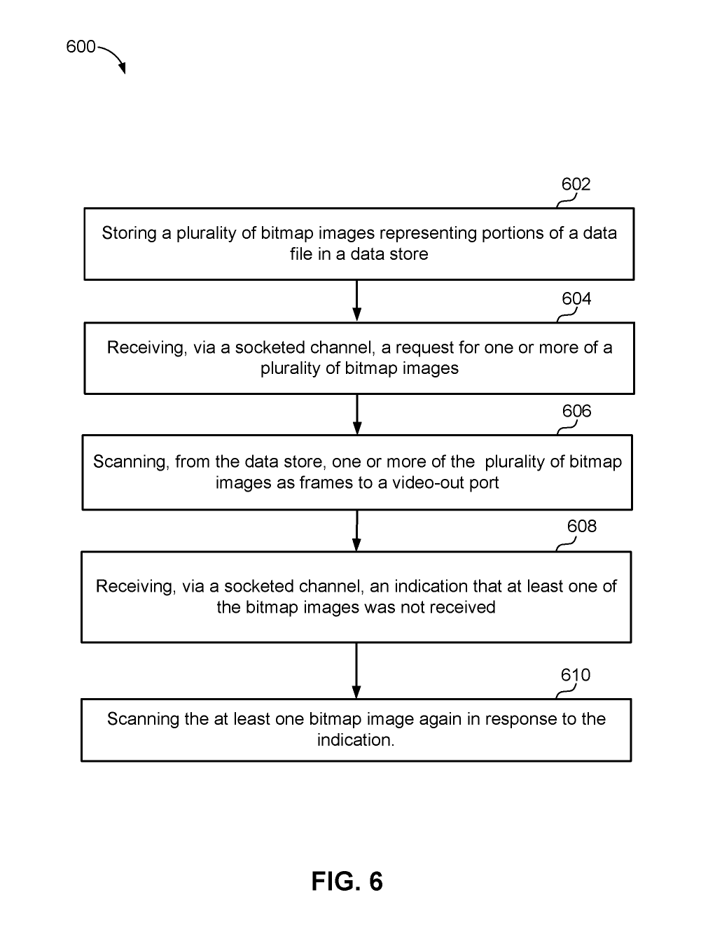

Referring now to FIG. 6, an example method 600 provides for transferring a data file via a video-out port. For example, method 600 may be performed by the storage device 210.

At 602, the method 600 may include storing a plurality of bitmap images representing portion of a data file in a data store. For instance, the data store 224 may store the plurality of bitmap images 254. The each bitmap image 254 may include at least a portion of the data file and header information for the portion of the data file. In an implementation, the bitmap images 254 may be precomputed by another device such as the sending device 100. The storage device 210 may receive the bitmap images 254 via an interface such as the network interface 218 and/or the USB interface 220. In another implementation, the data store 224 may be removable and a data store 224 storing the bitmap images 254 may be inserted into the storage device 210.

At 604, the method 600 may include receiving, via a socketed channel, a request for one or more of a plurality of bitmap images. For example, the HDMI file access function 250 may receive the request for one or more of the plurality of bitmap images via a socketed connection over the network interface 218 or the USB port 220. In an implementation, the socketed connection may also be established over the video-out port 234, for example, using an Ethernet and Audio Return channel of an HDMI port. The plurality of bitmap images may be stored in data store 224. In an implementation, the request may include an identifier of the one or more bitmap images. The identifier may correspond to the identifier included in the header portion of each bitmap image. The HDMI file access function 250 may identify the one or more bitmap images directly from the identifier. In another implementation, the request may include a file location. For example, the file location may be a location of a file or portion thereof in an emulated file system. That is, the receiving device 160 may view the storage device 210 as a different storage technology. The HDMI file access function 250 may use the file table 252 to map the file location to a bitmap image identifier. Accordingly, the HDMI file access function 250 may identify the one or more bitmap images based on the received file location.

At 606, the method 600 may include scanning, from a data store, a plurality of bitmap images as frames to a video-out port. For example, the HDMI file access function 250 may scan, from the data store 224, the plurality of bitmap images 254 to the video-out port 234. In an implementation, the HDMI file access function 250 may point the GPU 230 to a buffer including the next bitmap image 254 to be scanned out as a frame. The scanning by the GPU 230 may be slaved to a V-SYNC such that the GPU 230 scans out a bitmap image starting at the V-SYNC and finishing before the next V-SYNC. The HDMI file access function 250 may point the GPU 230 to the next bitmap image when the scanning is completed. In another implementation, the HDMI file access function 250 may operate in a similar manner as the converter 159 to instruct the GPU 230 to display the bitmap image in a full-screen mode.

At 608, the method 600 may include receiving, via the socketed channel, an indication that at least one of the bitmap images was not received. For example, the HDMI file access function 250 may receive the indication that at least one of the bitmap images was not received. As discussed above regarding action 506, the receiving device 160 may determine that a bitmap image is not received when either a received bitmap image is corrupted or a bitmap image with an expected identifier is not received.

At 610, the method 600 may include scanning the at least one bitmap image again in response to the indication. For example, the HDMI file access function 250 may scan the at least one bitmap image again in response to the indication. The scanning in action 608 may be performed in a similar manner to the scanning in action 604.

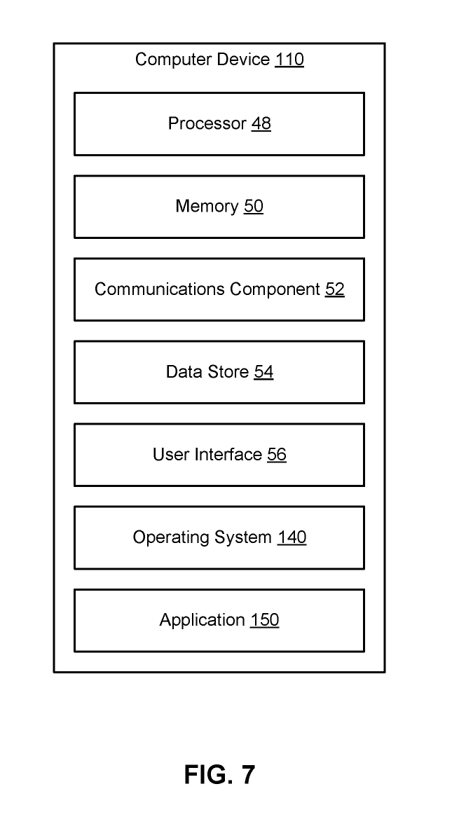

Referring now to FIG. 7, illustrated is an example computer device 110 in accordance with an implementation, including additional component details as compared to FIG. 1. In one example, computer device 110 may include processor 48 for carrying out processing functions associated with one or more of components and functions described herein. Processor 48 can include a single or multiple set of processors or multi-core processors. Moreover, processor 48 can be implemented as an integrated processing system and/or a distributed processing system. In an implementation, for example, processor 48 may include CPU 114 and/or GPU 130.

In an example, computer device 110 may include memory 50 for storing instructions executable by the processor 48 for carrying out the functions described herein. In an implementation, for example, memory 50 may include memory 116 and/or memory 132.

Further, computer device 110 may include a communications component 52 that provides for establishing and maintaining communications with one or more parties utilizing hardware, software, and services as described herein. Communications component 52 may carry communications between components on computer device 110, as well as between computer device 110 and external devices, such as devices located across a communications network and/or devices serially or locally connected to computer device 110. For example, communications component 52 may include one or more buses, and may further include transmit chain components and receive chain components associated with a transmitter and receiver, respectively, operable for interfacing with external devices. In an implementation, for example, communications component 52 may include network interface 122 and/or USB interface 124 and/or video-out port 134.

Additionally, computer device 110 may include a data store 54, which can be any suitable combination of hardware and/or software, that provides for mass storage of information, databases, and programs employed in connection with implementations described herein. For example, data store 54 may be a data repository for operating system 140 and/or applications 146. The data store 54 may store the data file 310. The data store may include memory 116 and/or memory 132.

Computer device 110 may also include a user interface component 56 operable to receive inputs from a user of computer device 110 and further operable to generate outputs for presentation to the user. User interface component 56 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, user interface component 56 may include one or more output devices, including but not limited to a display, a speaker, a haptic feedback mechanism, a printer, any other mechanism capable of presenting an output to a user, or any combination thereof.

In an implementation, user interface component 56 may transmit and/or receive messages corresponding to the operation of operating system 140 and/or application 146. In addition, processor 48 may execute operating system 140 and/or application 146, and memory 50 or data store 54 may store them.

As used in this application, the terms “component,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computer device and the computer device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various implementations or features may have been presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, and actions of methods described in connection with the embodiments disclosed herein may be implemented or performed with a specially-programmed one of a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computer devices, e.g., a combination of a DSP and a microprocessor, a plurality of microprocessors, one or more microprocessors in conjunction with a DSP core, or any other such configuration. Additionally, at least one processor may comprise one or more components operable to perform one or more of the steps and/or actions described above.

Further, the steps and/or actions of a method or procedure described in connection with the implementations disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some implementations, the processor and the storage medium may reside in an ASIC. Additionally, the ASIC may reside in a user terminal. In the alternative, the processor and the storage medium may reside as discrete components in a user terminal. Additionally, in some implementations, the steps and/or actions of a method or procedure may reside as one or any combination or set of codes and/or instructions on a machine readable medium and/or computer readable medium, which may be incorporated into a computer program product.

In one or more implementations, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While implementations of the present disclosure have been described in connection with examples thereof, it will be understood by those skilled in the art that variations and modifications of the implementations described above may be made without departing from the scope hereof. Other implementations will be apparent to those skilled in the art from a consideration of the specification or from a practice in accordance with examples disclosed herein.

What is claimed is:

1. A storage device for transferring a file, comprising:
a data store storing a plurality of bitmap images representing portions of a data file, wherein each bitmap image includes at least a portion of the data file and header information for the portion of the data file;
a video-out port; and
a processor configured to scan the bitmap images as frames to the video-out port.

2. The storage device of claim 1, further comprising an interface configured to provide a socketed connection to a second device connected to the storage device via the video-out port.

3. The storage device of claim 2, wherein the socketed connection utilizes an Ethernet channel over the video-out port.

4. The storage device of claim 1, wherein the socketed connection utilizes a network interface or a universal serial bus.

5. The storage device of claim 2, wherein the processor is configured to receive, via the socketed connection, a request for one or more of the plurality of bitmap images.

6. The storage device of claim 5, wherein the request includes an identifier of the one or more bitmap images.

7. The storage device of claim 5, wherein the request includes a file location and the storage device further comprises a file table configured to map the file location to an identifier of the one or more bitmap images.

8. The storage device of claim 2, wherein the processor is configured to:
receive, via the socketed connection, an acknowledgment identifying one or more of the scanned bitmap images that were not received by the second device; and
scan the one or more bitmap image as a frames to the video-out port in response to the acknowledgment.

9. A method of transferring a file comprising:
storing a plurality of bitmap images representing portions of a data file in a data store, wherein each bitmap image includes at least a portion of the data file and header information for the portion of the data file; and
scanning, from the data store, one or more of the plurality of bitmap images as frames to a video-out port.

10. The method of claim 9, wherein the header information includes an identifier of the bitmap image.

11. The method of claim 9, further comprising receiving, via a socketed channel, a request for one or more of the plurality of bitmap images.

12. The method of claim 11, wherein the request includes an identifier of the one or more bitmap images.

13. The method of claim 11, wherein the request includes a file location, wherein the method further comprises determining one or more identifiers of bitmap images based on the file location.

14. The method of claim 1, further comprising:
receiving, via a socketed connection, an acknowledgment identifying one or more of the scanned bitmap images that were not received by the second device; and
scanning the one or more bitmap image as a frames to the video-out port in response to the acknowledgment.

15. A computer device for accessing a file from a storage device, comprising:
a memory storing one or more parameters or instructions for executing an operating system;
a video-in port configured to receive a plurality of frames, wherein the video-in port is connected to a video-out port of the storage device;
a bidirectional interface providing a socketed connection to the storage device; and
at least one processor coupled to the memory, wherein the at least one processor is configured to:
request at least a portion of the file from the storage device via the socketed connection;
receive, via the video-in port, a plurality of video frames;
convert each of the video frames to a bitmap image including a header portion and a data portion; and
reconstruct the requested at least a portion of the file based on the data portion of each bitmap image according to the header portions.

16. The computer device of claim 15, wherein to reconstruct the data file, the processor is configured to:
perform a checksum on the data portion the bitmap image; and
compare the checksum to a checksum in the header portion of the bitmap image.

17. The computer device of claim 16, wherein the processor is configured to
determine that the checksums do not match; and
requesting the storage device to resend a frame corresponding to the bitmap image.

18. The computer device of claim 15, wherein the processor is configured to
determine, based on the header portions, that a bitmap image associated with the file was not received; and
request the source to resend the frame corresponding to the bitmap image.

19. The computer device of claim 15, wherein the data file is a video game, wherein the processor is configured to:
load the video game into memory; and
execute the video game.
